(19) United States
(12) Patent Application Publication
(10) Pub. No.: US 2017/0215432 A1
(43) Pub. Date: Aug. 3, 2017

(54) SYNERGIZED PLANT EXTRACT/ESSENTIAL OIL BLEND COMPRISING BASIL OIL

(71) Applicant: VAMA INC., Keokuk, IA (US)

(72) Inventor: KRISHNA PRASAD SUDHIR NAIR, KEOKUK, IA (US)

(21) Appl. No.: 15/330,190

(22) PCT Filed: Feb. 19, 2015
(86) PCT No.: PCT/US15/16704

§ 371 Date: Aug. 19, 2016

Related U.S. Application Data
(60) Provisional application No. 61/941,947, filed on Feb. 19, 2014.

(51) Int. Cl. A01N 65/22; A01N 65/36; A01N 65/44; A01N 65/10; A01N 65/24; A01N 65/06; A01N 25/04; A01N 65/28

(52) U.S. Cl. CPC A01N 65/22; A01N 25/04; A01N 65/36; A01N 65/28; A01N 65/10; A01N 65/24; A01N 65/06; A01N 65/44

(57) ABSTRACT

Compositions and methods for controlling mosquitoes are provided herein.

### CROSS-REFERENCE TO RELATED APPLICATIONS

The present application claims priority to U.S. Application Ser. No. 61/941,947, filed Feb. 19, 2014, which is incorporated herein by reference in its entirety.

### FIELD OF THE INVENTION

The present invention relates to environmentally safe compositions based on naturally occurring active ingredients for mosquito control. More particularly, the invention relates to compositions based on basil oil synergized plant extract/essential oil blends for all species & stages of mosquitoes.

### BACKGROUND OF THE INVENTION

Management of vector mosquito population and arthropods is of prime importance. Unfortunately, a number of highly effective insecticides are extremely harmful to both the environment and humans. Some of the most effective insecticides are synthetic. One major problem with synthetic insecticides is that they are non-biodegradable. Consequently, these insecticides remain in the ecosystem for a longer time, and severely affect organisms that subsequently absorb the insecticides. Apart from posing a problem to environment, the continued use of chemical insecticides results in gradual resistance in insects as well as in environmental pollution. Chemical insecticides are toxic to the non-target natural insects, which co-exist with mosquitos in the environment.

Over the years, efforts have been made to develop insecticides from naturally occurring compounds that are as effective as synthetic insecticides but at the same time are able to be quickly absorbed in the ecosystem. In addition to the ability to be absorbed and broken down in the ecosystem, it is also important that the insecticide should able to remain effective over a considerable period of time.

A number of natural insecticidal materials based on bacterial preparations lethal to insects are available commercially. However, the potential of non-bacterial, natural materials having insecticidal properties has largely been ignored, presumably because of the higher cost and lower insecticidal activity of such known natural substances.

The other known natural insecticides are natural pyrethrum and plant essential oils. The term “pyrethrum” is used to identify flower extracts that have long been known to possess insecticidal activity. Pyrethrums generally include the oleoresins of Chrysanthemum cinerariaefolium. These oleoresins contain several esters that are very effective insecticides against a wide range of insect pests. These esters, collectively called pyrethrins, are the most common botanical pesticides in the lawn and garden pesticide market. The pyrethrins are contact insecticides, causing rapid knockdown and mortality of insects at very low concentrations. As botanical products, these compounds are rapidly degraded through ultraviolet action on the pyrethrin molecules. In addition, the pyrethrins are quickly biodegraded by microorganisms. These features, combined with a relatively safe toxicological profile, have contributed to their commercial success against synthetic hydrocarbon-based pesticides. The molecular structure of the pyrethrin esters has been used by many different companies to develop synthetic compounds. These synthetic compounds, called pyrethroids, are not naturally occurring and have chemical structures that differ from those of pyrethrins. Apart from these, there are some synergized pyrethrum products, such as sesame oil synergized pyrethrin, piperonyl butoxide (PBO) synergized pyrethrin, azadiractin synergized pyrethrin etc, are also available for an enhanced insecticidal activity of pyrethrum based products. Even though they are effective, some of these synergists are carcinogenic or highly toxic to living organisms. The main draw backs of natural pyrcthrum and synergized pyrethrum products are its toxicity at higher concentration and the method of application.

Various formulations disclosed in the art make use of compositions of essential oils as insect repellents. Such formulations comprise different individual or blends of essential oils such as thyme oil, lilac oil, basil oil, neem oil, citronella oil, catnip oil, celery seed oil, lavender oil, lime oil, pennyroyal, lemon grass oil. fennel oil, cedar oil, clove oil, sandalwood, or peppermint oil. These oils are good repellents of mosquitoes and some are effective in killing mosquito larvae contributed to its chemoreceptor binding property. To date, these oils lack efficacy in the control of insects at lower oil concentrations.

Accordingly, it is an objective of the present invention to provide a new insecticide formulation that may control all the stages of mosquitoes, while being environmentally safe. It is also an objective of the present invention to provide a formulation that is entirely biodegradable. It is still another objective of the present invention to provide a formulation which minimizes the need for repeat application by maintaining its effectiveness over a period of time beyond the initial application for mosquito control. It is another objective of this invention to provide a formulation that is capable of controlling all species and stages of mosquitoes. It is a further objective to provide an insecticide in an aqueous form so that it can be applied directly by spraying or misting. A further objective of the present invention is to provide insecticidal compositions wherein the active synergistic compositions of the present invention can be employed in a reduced amount and still achieve the desired control over the insects.

These and other objectives and features of the invention will be apparent from the description and the claims which follow.

### SUMMARY OF THE INVENTION

In some embodiments, the invention provides effective formulations that include naturally occurring active ingredients. The formulations can be effective against some or all species of mosquitoes. The disclosed combinations of active ingredients have been observed to enhance the effectiveness of individual ingredients. They are particularly useful formulation when used to combat all lifecycle stages of mosquitoes.

Some embodiments of the present invention provide mosquito control compositions and methods that can have, if desired, a pleasant scent and that can be applied without burdensome safety precautions.

Some embodiments of the present invention provide easy application methods since the insecticidal formulation can be made in to aqueous form.

Some embodiments of the present invention provide a mosquito control formulation that maintains its effectiveness for a period of time after initial application thereby minimizing the need for repeat application.

The formulations of the present invention according to some embodiments can effectively control mosquitoes at absolute component concentrations significantly lower than that has previously been disclosed. The ability to effectively control insects using dilute preparations results in significant cost saving over prior compositions.

The basis for which some of the embodiments of the invention have been developed is due to our finding in some aspects that when composition of two or more particular essential oils and/or plant extracts with a natural surfactant, synergized with basil oil shows an enhanced activity over any species and stages of mosquitoes as it possess the property of inhibiting/activating neuron transmissions by binding at multiple receptors.

In one aspect, the present disclosure provides for a composition for repelling or killing mosquitos comprising a water emulsion of plant extracts and a natural surfactant. In some embodiments, the plant extracts are selected from one or more of basil, celery, cedarwood, cinnamon, clove, lilac, lemon eucalyptus, and lemongrass extracts. In some embodiments, an individual plant extract is present in an amount of about 2% to about 25% (v/v) or any sub value or sub range there between. In some embodiments, the natural surfactant is activated castor oil. In some embodiments, the natural surfactant is ethoxylated castor oil. In some embodiments, the surfactant is present in an amount of about 30% to about 50% (v/v) or any sub value or sub range there between. In some embodiments, the composition is a water emulsion, aqueous, concentrated or diluted ready-to-use form formulation.

In one aspect, the present disclosure provides for a composition for controlling mosquitos comprising a final concentration of one or more of about 9%-19% (v/v) (preferably about 14% (v/v)) lime oil, about 2%-12% (v/v) (preferably about 7% (v/v)) lilac oil, about 8%-18% (v/v) (preferably about 13% (v/v)) thyme oil, about 17%-22% (v/v) (preferably about 22% (v/v)) basil oil, about 1%-11% (v/v) (preferably about 6% (v/v)) clove oil, and about 33%-43% (v/v) (preferably about 38% (v/v)) castor oil. It should be understood that any of the above described components can be present at any sub value or sub range there between.

In one aspect, the present disclosure provides for a composition for controlling mosquitos comprising a final concentration of one or more of about 20%-30% (v/v) (preferably about 25% (v/v)) basil oil, about 5%-10% (v/v) (preferably about 8% (v/v)) clove oil, about 5%-15% (v/v) (preferably about 9% (v/v)) celery extract, about 9%-19% (v/v) (preferably about 14% (v/v)) thyme oil, and about 39%-49% (v/v) (preferably about 44% (v/v)) castor oil. It should be understood that any of the above described components can be present at any sub value or sub range there between.

In one aspect, the present disclosure provides for a composition for controlling mosquitos comprising a final concentration of one or more of about 9%-19% (v/v) (preferably about 14% (v/v)) basil oil, about 4%-14% (v/v) (preferably about 9% (v/v)) clove oil, about 5%-15% (v/v) (preferably about 10% (v/v)) celery extract, about 1%-9% (v/v) (preferably about 4% (v/v)) cinnamon oil, about 10%-20% (v/v) (preferably about 15% (v/v)) lemon eucalyptus oil, about 1%-8% (v/v) (preferably about 3% (v/v)) lilac oil, and about 40%-50% (v/v) (preferably about 45% (v/v)) castor oil. It should be understood that any of the above described components can be present at any sub value or sub range there between.

In one aspect, the present disclosure provides for a composition for controlling mosquitos comprising a final concentration of one or more of about 39%-49% (v/v) (preferably about 11% (v/v)) basil oil, about 2%-12% (v/v) (preferably about 7% (v/v)) cedar-wood oil, about 5%-15% (v/v) (preferably about 10% (v/v)) celery extract, about 1%-10% (v/v) (preferably about 5% (v/v)) cinnamon oil, about 10%-20% (v/v) (preferably about 15% (v/v)) lemon eucalyptus oil, about 3%-13% (v/v) (preferably about 8% (v/v)) thyme oil, about 1%-8% (v/v) (preferably about 3% (v/v)) lemon grass oil, and about 36%-46% (v/v) (preferably about 41% (v/v) castor oil. It should be understood that any of the above described components can be present at any sub value or sub range there between.

In one aspect, the present disclosure provides for a composition for controlling mosquitos comprising a final concentration of one or more of about 5%-15% (v/v) (preferably about 10% (v/v)) lime oil, about 1%-10% (v/v) (preferably about 5% (v/v)) Basil oil, about 1%-9% (v/v) (preferably about 4% (v/v)) clove oil, about 1%-9% (v/v) (preferably about 4% (v/v)) lilac oil, about 5%-15% (v/v) (preferably about 10% (v/v)) thyme oil, about 1%-7% (v/v) (preferably about 2% (v/v)) celery extract, about 1%-10% (v/v) (preferably about 5% (v/v)) cinnamon oil, about 5%-15% (v/v) (preferably about 10% (v/v)) lemon eucalyptus oil, and about 45%-55% (v/v) (preferably about 50% (v/v)) castor oil. It should be understood that any of the above described components can be present at any sub value or sub range there between.

In one aspect, the present disclosure provides for a composition for controlling mosquitos comprising a final concentration of one or more of about 17%-27% (v/v) (preferably about 22% (v/v)) basil oil, about 5%-15% (v/v) (preferably about 10% (v/v)) clove oil, about 3%-13% (v/v) (preferably about 8% (v/v)) lilac oil, about 5%-15% (v/v) (preferably about 10% (v/v)) cedar oil, and about 45%-55% (v/v) (preferably about 50% (v/v)) castor oil. It should be understood that any of the above described components can be present at any sub value or sub range there between.

In one aspect, the present disclosure provides for a composition for controlling mosquitos comprising a final concentration of one or more of about 1%-10% (v/v) (preferably about 5% (v/v)) lime oil, about 6%-16% (v/v) (preferably about 11% (v/v)) basil oil, about 1%-8% (v/v) (preferably about 3% (v/v)) celery extracts, about 3%-13% (v/v) (preferably about 8% (v/v)) thyme oil, about 5%-15% (v/v) (preferably about 10% (v/v)) cinnamon oil, about 4%-14% (v/v) (preferably about 9% (v/v)) lemon eucalyptus oil, about 2%-12% (v/v) (preferably about 7% (v/v)) lemon grass oil, and about 42%-52% (v/v) (preferably about 47% (v/v)) castor oil. It should be understood that any of the above described components can be present at any sub value or sub range there between.

In one aspect, the present disclosure provides for a composition for controlling mosquitos comprising a final concentration of one or more of about 10%-20% (v/v) (preferably about 15% (v/v)) lime oil, about 9%-19% (v/v) (preferably about 14% (v/v)) basil oil, about 1%-11% (v/v) (preferably about 6% (v/v)) clove oil, about 1%-9% (v/v) (preferably about 4% (v/v)) lilac oil, about 1%-9% (v/v) (preferably about 4% (v/v)) cinnamon oil, about 5%-15% (v/v) (preferably about 10% (v/v)) lemon eucalyptus oil, and about 42%-52% (v/v) (preferably about 47% (v/v)) castor oil. It should be understood that any of the above described components can be present at any sub value or sub range there between.

In one aspect, the present disclosure provides for a composition for controlling mosquitos comprising a final concentration of one or more of about 10%-20% (v/v) (preferably about 15% (v/v)) lime oil, about 10%-20% (v/v) (preferably about 15% (v/v)) basil oil, about 1%-10% (v/v) (preferably about 5% (v/v)) clove oil, about 1%-8% (v/v) (preferably about 3% (v/v)) lilac oil, about 1%-9% (v/v) (preferably about 4% (v/v)) celery extracts, about 1%-9% (v/v) (preferably about 4% (v/v)) cedar-wood oil, about 4%-14% (v/v) (preferably about 9% (v/v)) thyme oil, about 1%-10% (v/v) (preferably about 5% (v/v)) cinnamon oil, about 4%-14% (v/v) (preferably about 9% (v/v)) lemon eucalyptus oil, about 1%-7% (v/v) (preferably about 2% (v/v)) lemon grass oil, and about 25%-35% (v/v) (preferably about 30% (v/v)) castor oil. It should be understood that any of the above described components can be present at any sub value or sub range there between.

In one aspect, the present disclosure provides for a method of controlling mosquitos, said method comprising applying the compositions disclosed herein to a target area containing mosquitos. The amount applied can be any suitable amount to control or reduce the number of mosquito eggs, mosquito larvae, pupae of mosquitoes and/or mosquitos, and/or to kill the eggs, pupae of mosquitoes, mosquitos and/or larvae. The amount can be an amount that coats the area to which it is applied.

In some embodiments, the method of controlling mosquitos comprises applying the compositions disclosed herein at about 0.1 ml to about 10 ml of a final concentration to about 3 to about 9 square inches of a target area, such as exposed part of a body or skin for personal use. Also contemplated is any sub value or sub range within one or more of the ranges described in this paragraph.

In some embodiments, the method of controlling mosquitos comprises applying the compositions disclosed herein at about 1 ml of a final concentration to about 6 square inches of a target area, such as exposed part of a body or skin for personal use.

In some embodiments, the application lasts for about 1 to about 10 hours. In some embodiments, the application lasts for about 5 to about 6 hours. Also contemplated is any sub value or sub range within one or more of the ranges described in this paragraph.

In some embodiments, the method of controlling mosquitos comprises applying the composition disclosed herein at about 0.1 ml to about 10 ml of a final concentration per 0.5 cubic meter to 2 cubic meter of an outdoor location. Also contemplated is any sub value or sub range within one or more of the ranges described in this paragraph.

In some embodiments, the method of controlling mosquitos comprises applying the composition disclosed herein at about 2.5 ml of a final concentration per cubic meter of an outdoor location.

In some embodiments, the method of controlling mosquitos comprises applying the composition disclosed herein at about 0.1 ml to about 10 ml of a final concentration per cubic meter of an indoor location. Also contemplated is any sub value or sub range within one or more of the ranges described in this paragraph.

In some embodiments, the method of controlling mosquitos comprises applying the composition disclosed herein at about 1 ml of a final concentration per cubic meter of an indoor location.

In some embodiments, the method of controlling mosquitos comprises applying the composition disclosed herein at about 0.1 mL to about 10 mL per ½ meter to about 2 meter diameter of a water body, or approximately one squirt of about 1% to about 8% of a final concentration solution of the composition disclosed herein. Also contemplated is any sub value or sub range within one or more of the ranges described in this paragraph.

In some embodiments, the method of controlling mosquitos comprises applying the composition disclosed herein at about 1 ml per meter diameter of a water body, or approximately one squirt of 4% of a final concentration solution of the composition disclosed herein.

In some embodiments, the target area is selected from the group consisting of rooms, offices, beds, furniture, fields, agriculture planting areas, gardens, plants, animals, agricultural fields, landscaped areas (including lawns), other types of fields and grounds, ponds, lakes, streams, rivers, eaves, gutters, bird baths, ornamental fountains and ponds, ornamental pools, swimming pools and hot tubs, puddles, ground water, water storage tanks, and other bodies of water, flower pots and pot water collection trays and bowls, containers including ornamental containers, trash cans, outdoor holding pens or coops for livestock, poultry and other animals, greenhouses, barns, chicken coops or barns, livestock pens and the like.

In one aspect, the present disclosure provides for an use of a composition disclosed herein in a method of controlling mosquitos by applying the composition to a target area containing mosquitos. In some embodiments, the target area is an outdoor location or an indoor location. The amount applied can be any suitable amount to control or reduce the number of mosquito eggs, mosquito larvae, pupae of mosquitoes and/or mosquitos, and/or to kill the eggs, pupae of mosquitoes, mosquitos and/or larvae. The amount can be an amount that coats the area to which it is applied.

In some embodiments, the outdoor location includes one or more of agricultural fields, agriculture planting areas, gardens, plants, landscaped areas, other types of fields and grounds, ponds, lakes, rivers and other bodies of water, outdoor holding pens or coops for livestock, poultry and other animals. In some embodiments, the indoor location includes one or more of rooms, offices, greenhouses, barns, chicken coops or barns, livestock pens and the like. The amount applied can be any suitable amount to control or reduce the number of mosquito eggs, mosquito larvae, pupae of mosquitoes and/or mosquitos, and/or to kill the eggs, pupae of mosquitoes, mosquitos and/or larvae. The amount can be an amount that coats the area to which it is applied.

In one aspect, the present disclosure provides for an application device comprising the composition disclosed herein. In some embodiments, the application device can be one or more of a spray bottle, an aerosolized spray can, a foam applicator, a fogger, and a compression sprayer. In some embodiments, the application device further comprises additional ingredients having a mosquito repelling activity.

In one aspect, the present disclosure provides a composition for controlling mosquitos that further comprising a carrier, wherein said carrier provides the form of a solid, liquid, powder or foam. In some embodiments, the carrier is suitable for distribution of the formulation through spraying, spreading, coating, dripping, dissolving or sprinkling.

Additional objectives and attendant advantages of the present invention will be set forth, in part, in the description that follows, or may be learned from practicing or using the present invention. The objectives and advantages may be realized and attained by means of the instrumentalities and combinations particularly recited in the appended claims. It is to be understood that the foregoing general description and the following detailed description are exemplary and explanatory only and are not to be viewed as being restrictive of the invention, as claimed.

### BRIEF DESCRIPTION OF DRAWINGS

FIG. 1 is the tabular summary of the larvicidal activity of Formulation A (FIG. 1A) and Formulation C (FIG. 1B) against Anopheles stephensi mosquito larvae.

FIG. 2 is the tabular summary of the larvicidal activity of Formulation B (FIG. 2A) and Formulation E (FIG. 2B) against Anopheles stephensi mosquito larvae.

FIG. 3 is the tabular of the larvicidal activity of Formulation D against Aedes aegypti mosquito larvae.

FIG. 4 is the tabular summary of the adulticidal activity of Formulation I against Culex quinquefasciatus adult mosquitos.

FIG. 5 is the tabular summary of the adulticidal activity of Formulation I against Aedes aegypti adult mosquitos.

FIG. 6 is the tabular summary of adulticidal activity of Formulation H against Anopheles stephensi adult mosquitos.

FIG. 7 is the tabular summary of the repellency of Formulation A against different mosquito species.

FIG. 8 is the tabular summary of the mosquito repellency on humans of the various formulations.

### DETAILED DESCRIPTION OF THE INVENTION

It is to be understood that this invention is not limited to particular embodiments described, as such may, of course, vary. It is also to be understood that the terminology used herein is for the purpose of describing particular embodiments only, and is not intended to be limiting, since the scope of this invention will be limited only by the appended claims.

The detailed description of the invention is divided into various sections only for the reader's convenience and disclosure found in any section may be combined with that in another section. Unless defined otherwise, all technical and scientific terms used herein have the same meaning as commonly understood by one of ordinary skill in the art to which this invention belongs.

It must be noted that as used herein and in the appended claims, the singular forms “a”, “an”, and “the” include plural referents unless the context clearly dictates otherwise. Thus, for example, reference to “a compound” includes a plurality of compounds.

### I. Definitions

Unless defined otherwise, all technical and scientific terms used herein have the same meaning as commonly understood by one of ordinary skill in the art to which this invention belongs. As used herein the following terms have the following meanings.

As used therein, the term “about” when used before a numerical designation, e.g., temperature, time, amount, concentration, and such other, including a range, indicates approximations which may vary by (+) or (−) 20%, 10%, 5%, 1%, or any subrange or subvalue there between.

As used herein, the term “Comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this invention.

As used herein, the term “controlling” refers to knock-down and/or killing at least a portion of the target insects (e.g., mosquito eggs, mosquito larvae, and mosquitoes) present in a treatment area. In one embodiment, at least about 70% of the target insects are killed. In one embodiment, at least about 75% of the target insects are killed. In one embodiment, at least about 80% of the target insects are killed. In a preferred embodiment, at least about 85% of the target insects are killed. In an especially preferred embodiment, at least about 90% of the target insects are killed. In one embodiment, at least about 95% of the target insects are killed. In one embodiment, about 100% of the target insects are killed.

As used herein, the term “target area” refers to a physical location, plant, or animal that is to be treated with the composition described herein. Examples of target areas include but are not limited to rooms, offices, fields, ponds, swimming pools, agriculture planting areas, gardens, plants, and animals.

Percentages recited herein indicate percentage by volume (v/v), unless otherwise noted. Percentages recited herein indicate the final concentration of the component in the ready-to-use composition. That is, a concentrated formulation of the composition will comprise a higher concentration of each ingredient (e.g., essential oil and/or surfactant) such that it is diluted (e.g., with water) to the final concentration prior to use. For any of the ranges or concentrations provided, also contemplated is any sub range or sub value there between.

As used herein, the term “naturally occurring ingredients” means plant extracts, plant derived fragrances, flavors, and colors.

As used herein, the term “essential oil” refers to a concentrated hydrophobic liquid containing volatile aroma compounds from plants. Essential oils are also known as volatile oils, ethereal oils, or aetherolea, or simply as the “oil of” the plant from which they were extracted, such as oil of clove. An oil is “essential” in the sense that it carries a distinctive scent, or essence, of the plant.

As used herein, the term “surfactant” means compounds that lower the surface tension between two liquids or between a liquid and a solid. Surfactants may act as detergents, wetting agents, emulsifiers, foaming agents, and dispersants. Herein, surfactants allow the oils to disperse in water.

### Compositions

The present invention according to some embodiments relates to novel synergistic compositions for insect (e.g., mosquito) control. In one aspect, the compositions as described herein are used to control mosquitoes. The mosquito control compositions of the invention comprise two or more plant essential oils/plant extract synergized with basil oil. The composition also includes a natural surface acting agent, within which the plant essential oils/plant extracts and basil oil is solubilized. The surface acting agent at least serves as an adjuvant and in some instances acts as a co-active ingredient.

The mosquito control formulation of the invention is preferably prepared as a concentrate and is subsequently diluted for use to a ready-to-use form. A preferred formulation, in concentrate form, comprises (1) about 5 to about 45 percent by volume of a blend of two or more plant essential oils/plant extracts; (2) about 5% to about 25% (v/v) of basil oil; and (3) about 30% to about 50% (v/v) of the natural surface acting agent. The concentrate may be diluted from between about 10:1 to about 100:1, and preferably from about 25:1 to about 50:1, with water to yield a ready-to-use formulation comprising about 2.0 to about 4.0 percent by volume of the blend of basil oil synergized plant essential oil/plant extract. Plant essential oil/plant extracts used in this invention, apart from basil oil, without limitation, are lime oil, lilac oil, thyme oil, clove oil, cedar wood oil, cinnamon oil, lemon eucalyptus oil, lemon grass oil and celery extract. In one aspect, the natural surfactant which also contributes to stability of this formulation is activated castor oil.

Plant essential oils/plant extracts, which are extracted from natural sources, generally contains, as a major constituent, an acyclic monoterpene alcohol or aldehyde, a benzenoid aromatic compound containing at least one oxygenated substituent or side chain, or a monocarbocyclic terpene generally having a six membered ring bearing one or more oxygenated substituents. Apart from these major constituents there are a number of other components also available in each essential oil.

Some non-limiting examples of the major constituents of essential oils which are used in this invention are, linalool, limonene, α-terpineol, amyl cinnamic aldehyde, amyl salicylate, anisic aldehyde, cinnamaldehyde, cinnamic alcohol, carvacrol, carveol, citral, citronellal, citronellol, dimethyl salicylate, eucalyptol (cineole), eugenol, iso-eugenol, galaxolide, geraniol, guaiacol, ionone, d-limonene, menthol, methyl anthranilate, methyl ionone, methyl salicylate, alpha-phellandrene, perillaldehyde, piperonal, D-pulegone, terpinen-4-ol, terpinyl acetate, 4-tert butylcyclohexyl acetate, thymol, trans-anethole and vanillin. The mosquito control formulations in the present invention consists at least two or more of the above components with activated castor oil.

In one aspect, the surface-active agent is a natural surfactant. In another aspect, the natural surfactant may also possess a synergistic effect and contributes to stability.

In a preferred aspect, the surface-active agent is castor oil. In one aspect, the surface-active agent is activated castor oil.

In still another aspect, castor oil is activated preferably ethoxylated. Activated Castor oil is referred to as Ethoxylated castor oil, which is a bi-product of ethoxylation process using castor oil and ethylene oxide. They are non-ionic surfactants that are widely used in oral, topical as well as prescription formulation. They could be employed as emulsifying or solubilizing agents as well, and are ideal for the aqueous preparations.

Castor oil is a vegetable-based oil made from Castor plant (ricinus communis) seeds. It naturally biodegrades quickly, is non-toxic and comes from a renewable energy resource (plants). About 90% of Castor seed oil contains the unusual hydroxy fatty acid ricinoleate (ricinoleic acid). Ricinoleic acid inhibits the growth of many viruses, bacteria, yeasts, and molds, like its derivative undecylenic acid. It also exerts analgesic and anti-inflammatory effects. Castor oil is used in non-limiting products such as adhesives, brake fluids, caulks, cosmetics, drugs, dyes, electrical liquid dielectrics, humectants, hydraulic fluids, inks, lacquers, leather treatments, lubricating greases, machining oils, paints, pesticides-fungicides, pigments, refrigeration lubricants, rubbers, sealants, textiles, washing powders, and waxes. Castor oil also effectively repels all species of mosquitoes. Activated castor oil, ethoxylated castor oil, is used in the mosquito control formulations of the present invention and has an increased surface acting property. It is also found in the present invention that the activated castor oil offers an extended stability to the formulations.

Without being bound by theory, it is believed that the mosquito control action (e.g., repel and knock down the adult mosquitoes and combat eggs, larvae and pupae of mosquitoes) of essential oils is mainly due to the binding of its constituents at various receptor sites, thereby inhibiting or activating neuron transmission. They are effective for the disruption of receptors such as but not limited to cyclic adenosine monophosphate (cAMP)/cAMP-dependent protein kinase, tyrosine kinase, MEK 1 or MEK 2, calcium phospholipid-dependent protein kinase (PKC), mitogen activated protein kinase family members, calcium-calmodulin-dependent protein kinase, growth factor receptor, and octopamine receptor. This neuron-toxicity is enhanced when the specific blend of essential oils and plant extracts are synergized with basil oil, both in ethoxylated castor oil carrier. Without wishing to be bound by theory, it is postulated that plant extract and essential oil antagonize a insect's nerve receptors or may act as P-450 inhibitors. Alternatively, plant extract and essential oil may act via an alternative mode of action. The ingredients in the plant extract and essential oil may also disrupt energy levels within the insect's metabolism, thereby synergizing the antagonistic action of so-called octopamine affectors. In any event, the net effect of the increased toxicity and synergized action of the novel and inventive synergistic composition disclosed herein is surprising and unexpected.

In one embodiment, this invention further encompasses an application device comprising the composition as described herein. The application device may be any suitable device for applying liquid insecticide. In one embodiment, the application device is selected from the group consisting of a spray bottle, an aerosolized spray can, a foam applicator, a fogger, and a compression sprayer.

The insecticidal composition of the invention can be prepared in various forms, including sprayable liquids and aerosols. A sprayable liquid form is preferred. Liquid compositions may be prepared in a concentrated form or in a ready-to-use form. A concentrated formulation is primarily a emulsifiable composition in which the castor oil is believed to contribute to some level of activity, and is also a solvent and a carrier for essential oils. This composition can be diluted with water before application. Ready-to-use formulations are stable aqueous emulsions in which water is the primary ingredient, yet the basil oil and plant extract and essential oil are present at sufficient concentrations to provide insecticidal activity.

The composition of the invention may be applied in areas that are infested with pests, including in domestic areas, garden areas and on or around trees and shrubs.

The composition is particularly effective and useful to combat mosquitoes.

In another embodiment of the invention the formulation is in aqueous form. In yet another embodiment said formulation is provided in concentrated form that can be diluted with water at the time of use.

In another embodiment the formulation is applied directly by spraying or misting.

In still another embodiment the formulations of the present invention are target specific, and safe and non-toxic to human beings and other non-target organisms.

### EXAMPLES

The present invention is described with reference to the following examples, which are given by way of illustration and should not be construed to limit the scope of the present invention.

### Example 1

The mosquito control formulations of the present invention are prepared by combining and thoroughly mixing the components. A ready-to-use formulation is prepared by adding all ingredients, except water, to the activated castor oil while stirring thoroughly. Thereafter, desired percentage of final ready to use product is prepared by adding the mixture to water while rapidly agitating. Various formulations prepared in accordance with the present invention are exemplified in Table 1.

TABLE 1

| | % in formulations v/v | | | | | | | | |
|---|---|---|---|---|---|---|---|---|---|
| Essential Oils | A | B | C | D | E | F | G | H | I |
| Lime | 10-20 | | | | 5-10 | | 2-5 | 5-15 | 10-15 |
| Basil | 15-25 | 20-25 | 10 to 15 | 5-15 | 5-15 | 15-25 | 5-15 | 5-15 | 10-15 |
| Clove | 5-15 | 5-10 | 5-15 | | 2-5 | 5-10 | | 5-10 | 5-10 |
| Lilac | 5-10 | | 2-5 | | 2-5 | 5-10 | | 2-5 | 2-5 |
| Celery | | 5-10 | 5-10 | 5-10 | 2-5 | | 2-5 | | 2-7 |
| Cedarwood | | | | 2-7 | | 5-10 | | | 2-7 |
| Thyme | 5-15 | 5-15 | | 5-10 | 5-10 | | 5-15 | | 5-10 |
| Cinnamon | | | 2-5 | 2-5 | 2-5 | | 5-10 | 2-5 | 2-5 |
| Lemon | | | 5-15 | 10-20 | 5-10 | | 5-10 | 5-10 | 5-10 |
| Eucalyptus | | | | | | | | | |
| Lemon Grass | | | | 2-7 | | | 2-7 | | 2-5 |
| Ethoxylated | 30-50 | 30-50 | 30-50 | 30-50 | 30-50 | 30-50 | 30-50 | 30-50 | 30-50 |
| Castor | | | | | | | | | |

### Example 2

The exemplary concentrated formulations are made by combining and thoroughly mixing the components. Ready-to-use formulations can be prepared by adding all ingredients, except water, to the activated castor oil while stirring thoroughly. Thereafter, desired percentage of final ready to use product is prepared by adding the mixture to water while rapidly agitating.

Exemplary concentrated formulations are given below:

### Formulation (A)

| Components | Percentage (%) v/v |
|---|---|
| Lime oil | 14 |
| Lilac oil | 7 |
| Thyme oil | 13 |
| Basil | 22 |
| Clove | 6 |
| Castor oil | 38 |

### Formulation (B)

| Components | Percentage (%) v/v |
|---|---|
| Basil oil | 25 |
| Clove Oil | 8 |
| Celery Extracts | 9 |
| Thyme Oil | 14 |
| Castor oil | 44 |

### Formulation (C)

| Components | Percentage (%) v/v |
|---|---|
| Basil oil | 14 |
| Clove Oil | 9 |
| Celery Extracts | 10 |
| Cinnamon Oil | 4 |
| Lemon eucalyptus oil | 15 |
| Lilac oil | 3 |
| Castor oil | 45 |

### Formulation (D)

| Components | Percentage (%) v/v |
|---|---|
| Basil oil | 11 |
| Cedarwood Oil | 7 |
| Celery Extracts | 10 |
| Cinnamon Oil | 5 |
| Lemon eucalyptus oil | 15 |
| Thyme oil | 8 |
| Lemon Grass oil | 3 |
| Castor oil | 41 |

### Formulation (E)

| Components | Percentage (%) v/v |
|---|---|
| Lime Oil | 10 |
| Basil oil | 5 |
| Clove Oil | 4 |
| Lilac Oil | 4 |
| Thyme Oil | 10 |
| Celery Extracts | 2 |
| Cinnamon Oil | 5 |
| Lemoneucalyptus oil | 10 |
| Castor oil | 50 |

### Formulation (F)

| Components | Percentage (%) v/v |
|---|---|
| Basil oil | 22 |
| Clove Oil | 10 |
| Lilac Oil | 8 |
| Ccdarwood Oil | 10 |
| Castor oil | 50 |

### Formulation (G)

| Components | Percentage (%) v/v |
|---|---|
| Lime Oil | 5 |
| Basil oil | 11 |
| Celery Extracts | 3 |
| Thyme Oil | 8 |
| Cinnamon Oil | 10 |
| Lemoneucalyptus oil | 9 |
| Lemon Grass Oil | 7 |
| Castor oil | 47 |

### Formulation (H)

| Components | Percentage (%) v/v |
|---|---|
| Lime Oil | 15 |
| Basil oil | 14 |
| Clove Oil | 6 |
| Lilac Oil | 4 |
| Cinnamon Oil | 4 |
| Lemoneucalyptus oil | 10 |
| Castor oil | 47 |

### Formulation (I)

| Components | Percentage (%) v/v |
|---|---|
| Lime Oil | 15 |
| Basil oil | 15 |
| Clove Oil | 5 |
| Lilac Oil | 3 |
| Celery extracts | 4 |
| Cedarwood Oil | 3 |
| Thyme | 9 |
| Cinnamon Oil | 5 |
| Lemoneucalyptus oil | 9 |
| Lemongrass Oil | 2 |
| Castor oil | 30 |

### Example 3

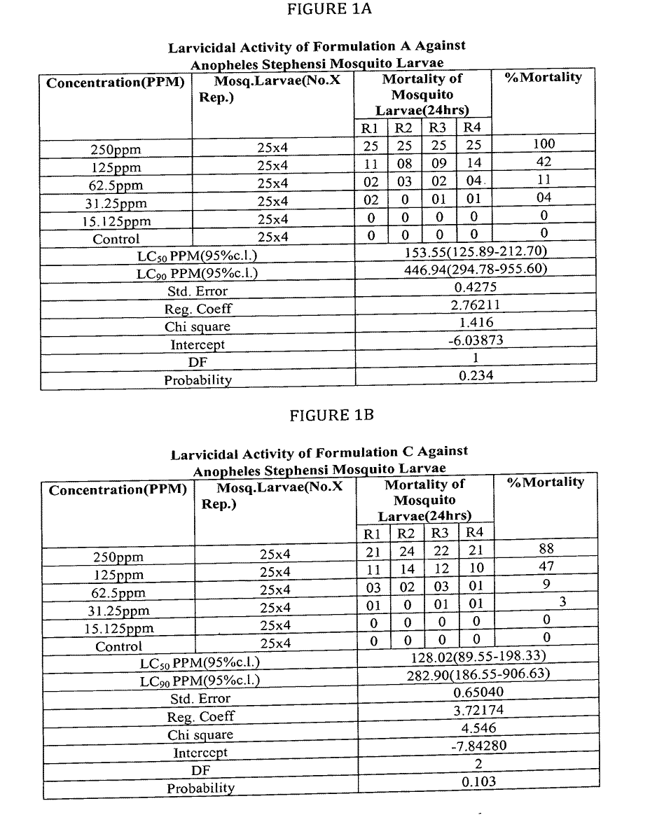

Larvicidal studies were carried out on larvae of mosquito species following the standard WHO method described in common protocol (whqlibdoc.who.int/hq/2005/who_cds_whopes_gcdpp_2005.13.pdf), which is incorporated by reference in its entirety. Results are summarized in FIG. 1. For evaluating the larvicidal efficacy of formulations, formulation A (FIG. 1A) and C (FIG. 1B), late III and IV instar mosquito larvae of the species Anopheles stephensi in replicates of 25 each were exposed to a range of test concentrations in 250 ml chlorine free water. Test concentrations prepared were 15.125 ppm, 31.25 ppm, 62.5 ppm, 125 ppm, and 250 ppm. Appropriate controls were run simultaneously. Four replicas were set for each test concentration along with appropriate controls.

After 24 hours of treatment, mortality was determined scoring the dead and moribund larvae in test and control replicates. From the data provided in FIG. 1A, Formulation A proved to have an excellent Larvicidal action against Anopheles stephensi mosquito species with 100% mortality at 250 ppm in 24 hours. Formulation C (FIG. 1B) also shows a good larvicidal activity against Anopheles stephensi mosquito species with 88% mortality at 250 ppm in 24 hours.

### Example 4

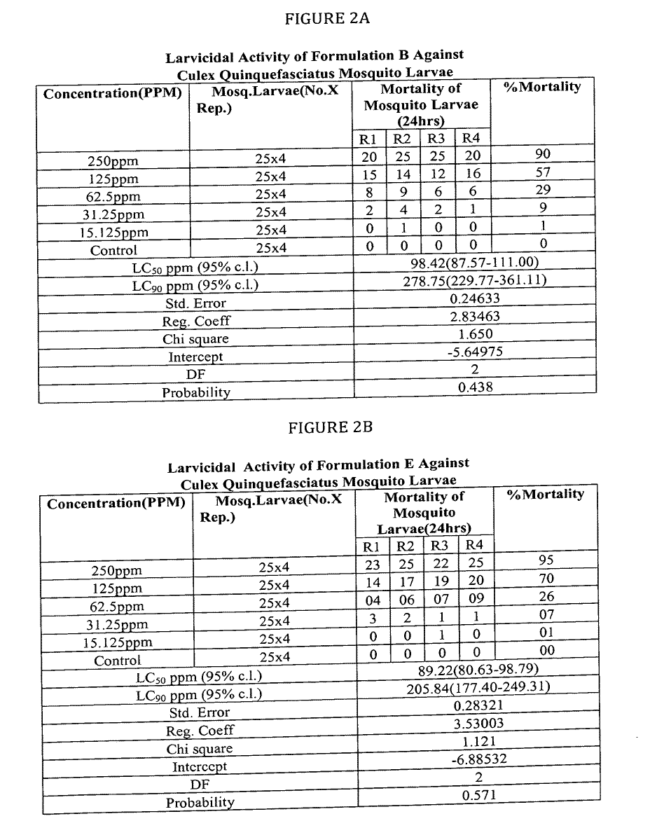

Larvicidal studies were carried out on larvae of mosquito species following the standard WHO method described in common protocol. Results are summarized in FIG. 2. For evaluating the larvicidal efficacy of formulations, formulation B (FIG. 2A) and E (FIG. 2B), late III and IV instar mosquito larvae of the species Culex Quinquefasciatus in replicates of 25 each were exposed to a range of test concentrations in 250 ml chlorine free water. Test concentrations prepared were 15.125 ppm, 31.25 ppm, 62.5 ppm, 125 ppm, and 250 ppm. Appropriate controls were run simultaneously. Four replicas were set for each test concentration along with appropriate controls.

After 24 hours of treatment, mortality was determined scoring the dead and moribund larvae in test and control replicates software. From the data provided in FIG. 2B, Formulation E proved to have an effective Larvicidal action against Culex Quinquefasciatus mosquito species with 95% mortality at 250 ppm in 24 hours. Formulations (FIG. 2A) also show a good larvicidal activity against Culex Quinquefasciatus mosquito species with 90% mortality at 250 ppm in 24 hours.

### Example 5

Larvicidal studies were carried out on larvae of mosquito species following the standard WHO method described in common protocol. Results are summarized in FIG. 3. For evaluating the larvicidal efficacy of formulations, formulation D, late III and IV instar mosquito larvae of the species Aedes aegypti in replicates of 25 each were exposed to a range of test concentrations in 250 ml chlorine free water. Test concentrations prepared are 15.125 ppm, 31.25 ppm, 62.5 ppm, 125 ppm, and 250 ppm. Appropriate controls were run simultaneously. Four replicas were set for each test concentration along with appropriate controls.

After 24 hours of treatment, mortality was determined scoring the dead and moribund larvae in test and control replicates. It is evident from the data given in FIG. 3 that Formulation D is effective in killing 92% Aedes aegypti larvae in 24 hours at a concentration of 250 ppm.

### Example 6

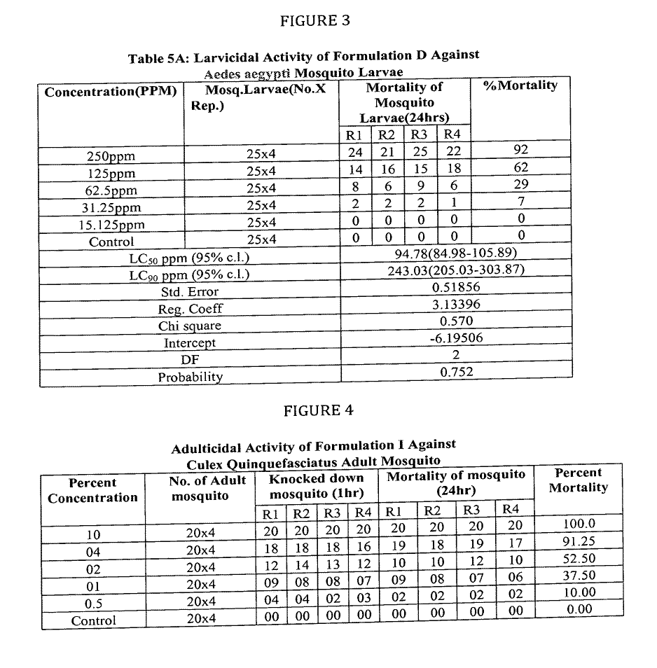

The efficacy of the ‘Formulation I’ against adult Mosquito, Culex quinquefasciatus, was evaluated following standard WHO guidelines. Knockdown in one hour and mortality in 24 hours were observed for different percentage concentration. Results are shown in FIG. 4. Formulation I exhibited 100% mortality of caged adult mosquitoes of species Culex Quinquefasciatus after 24 hours of application at 10% concentration. Also a >90% knockdown is observed in 1 hour at a concentration of 4% (FIG. 4).

### Example 7

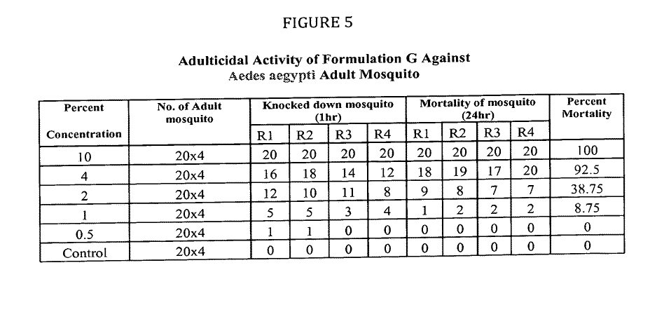

The efficacy of the ‘Formulation G’ against adult Mosquito, Aedes aegypti, is evaluated following standard WHO guidelines. Knockdown in one hour and mortality in 24 hours were observed for different percentage concentration. Results are shown in FIG. 5. Formulation G exhibited 92.5% mortality of caged adult mosquitoes of species Aedes aegypti after 24 hours of application at 4% concentration. At 10% concentration it gives 100% knockdown in 1 hour.

### Example 8

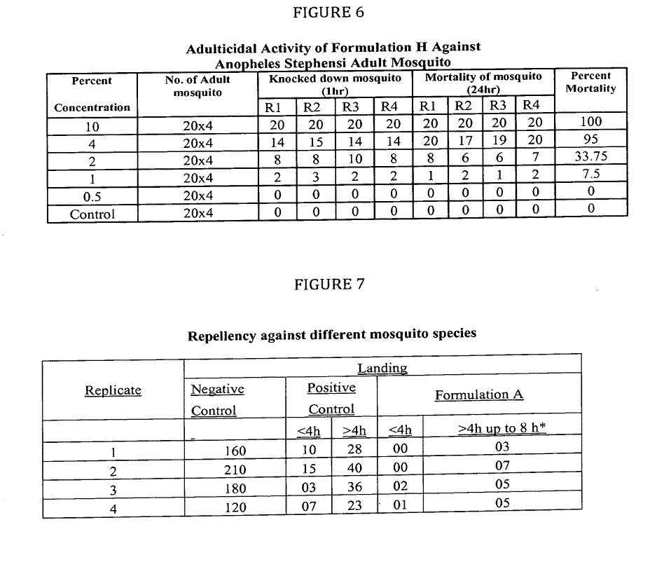

The efficacy of the ‘Formulation H’ against adult Mosquito, Anopheles Stephensi, is evaluated following standard WHO guidelines. Knockdown in one hour and mortality in 24 hours are observed for different percentage concentration. Results are shown in FIG. 6. Formulation H exhibited 95% mortality of caged adult mosquitoes of species Anopheles stephensi after 24 hours of application at 4% concentration. At 10% concentration it gives 100% knockdown in 1 hour.

### Example 9

As shown in FIG. 7, studies were carried out in the laboratory at 25° to 27° C. and 60-70% relative humidity using laboratory-reared strains of Anopheles, Aedes, Stephinsi and Culex mosquito vectors in cloth cages (2 cubic feet). Studies were carried out against each individual species in replicates of three in each of the replicate cage, one hundred 3 to 5-day old sugar—fed female mosquitoes were held. Mosquito that are pre-starved for 4 hr or more prior to testing were used for the experiment.

Five plastic bowls with sugar—soaked cotton (10% in water) were placed at four opposing corners and one in the middle of the cage. These bowls were treated with the specified concentration of the composition described in Example 3, one specified concentration of DEET (know synthetic repellent compound as positive control) and one with only sugar-soaked cotton (Negative control). The four treated bowls were placed in four opposing corners while the untreated negative control in the middle on the floor of the cage. Five-minute landing counts were made at 0, 1, 2, 3, 4, and 6 hours with the cups were removed between the exposure intervals. Mean percent repellency for each percent formulation and species was calculated based on the data of the three replicates at the given times of observation.

It is evident from the data that Formulation A has shown more repellency than known synthetic repellent DEET. In 4 hrs DEET repelled 97% mosquitoes, whereas Formulation-A repelled 99.9% mosquitoes. In the period of 4-8 hours, Formulation-A have repelled 97% mosquitoes with reference to the control. After 4 hrs DEET was repelling only 79% mosquitoes with reference to the control.

### Example 10

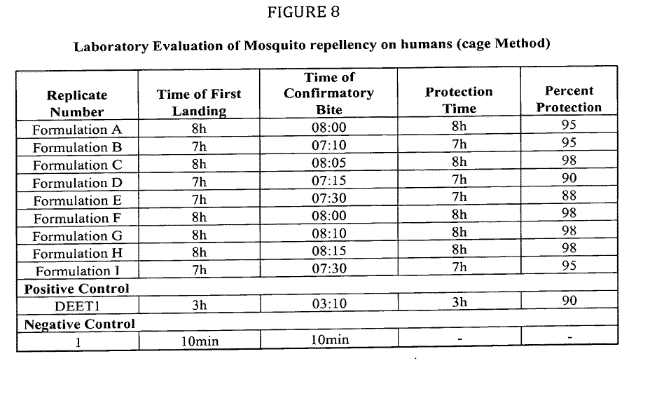

Results from mosquito repellency experiments on humans are shown in FIG. 8. Approximately a 25 cm area of one arm of human volunteer was marked on the skin with marker and the 4% Formulation applied on the marked portion. Remaining exposed area was covered with a proper sleeve. Exposures were made sequentially of an arm with application of the base solvent (fractionated coconut oil) alone followed by 4% formulation. Hands were put into cages containing approximately 100-150 three-day old, 4-hour starved mosquitoes in a 2×2×2 foot cloth cage. The propensity of mosquito biting was ensured by inserting an untreated hand into the cage. However, before the start of each exposure, the bare hand used as control (only solvent) of volunteer was exposed for 30 seconds. Observations are made for the three minutes of every half an hour exposure. If at least two mosquitoes landed on or bit the hand, the repellency test was continued. The test was continued until at least two bites occur and followed by a confirmatory bite (second bite) in the following exposure period. The time between application of the repellent and the second successive bite was recorded as the protection time. The effective dose (ED90) was calculated by probit analysis. Emphasis was on percent protection in relation to dose and time after treatment. The experiments had one positive control with known synthetic repellents, DEET, and negative control, only solvent, that is used as base for preparing the test repellent.

It is evident, from the data in FIG. 8, that all the formulations used in this trial are effective in protecting human body from mosquito bites. All the formulations have shown more than 95% percentage protection and a protection time of 7-8 hours. From the observed data on the repellency against the different mosquito species it can be concluded that a dose of 4% could be used for achieving the desired level of protection against bites of these mosquitoes.

1. A composition for repelling or killing mosquitos comprising a water emulsion of plant extracts and a natural surfactant.

2. The composition of claim 1, wherein the plant extracts are selected from the group consisting of basil, celery, cedarwood, cinnamon, clove, lilac, lemon eucalyptus, and lemongrass extracts.

3. The composition of claim 2, wherein an individual plant extract is present in an amount of about 2% to about 25% (v/v).

4. The composition of claim 1, wherein the natural surfactant is activated castor oil.

5. The composition of claim 1, wherein the natural surfactant is ethoxylated castor oil.

6. The composition of any one of claim 1 wherein the surfactant is present in an amount of about 30% to about 50% (v/v).

7. The composition of claim 1 wherein the composition is a water emulsion, aqueous, concentrated or diluted ready-to-use form formulation.

8. A composition according to claim 1 for controlling mosquitos comprising a final concentration of about 14% (v/v) lime oil, about 7% (v/v) lilac oil, about 13% (v/v) thyme oil, about 22% (v/v) basil oil, about 6% (v/v) clove oil, and about 38% (v/v) castor oil.

9. A composition according to claim 1 for controlling mosquitos comprising a final concentration of about 25% (v/v) basil oil, about 8% (v/v) clove oil, about 9% (v/v) celery extract, about 14% (v/v)thyme oil, and about 44% (v/v) castor oil.

10. A composition according to claim 1 for controlling mosquitos comprising a final concentration of about 14% (v/v) basil oil, about 9% (v/v) clove oil, about 10% (v/v) celery extract, about 4% (v/v) cinnamon oil, about 15% (v/v) lemon eucalyptus oil, about 3% (v/v) lilac oil, and about 45% (v/v) castor oil.

11. A composition according to claim 1 for controlling mosquitos comprising a final concentration of about 11% (v/v) basil oil, about 7% (v/v) cedar-wood oil, about 10% (v/v) celery extract, about 5% (v/v) cinnamon oil, about 15% (v/v) lemon eucalyptus oil, about 8% (v/v) thyme oil, about 3% (v/v) lemon grass oil, and about 41% (v/v) castor oil.

12. A composition according to claim 1 for controlling mosquitos comprising a final concentration of about 10% (v/v) lime oil, about 5% (v/v) Basil oil, about 4% (v/v) clove oil, about 4% (v/v) lilac oil, about 10% (v/v) thyme oil, about 2% (v/v) celery extract, about 5% (v/v) cinnamon oil, about 10% (v/v) lemon eucalyptus oil, and about 50% (v/v) castor oil.

13. A composition according to claim 1 for controlling mosquitos comprising a final concentration of about 22% (v/v) basil oil, about 10% (v/v) clove oil, about 8% (v/v) lilac oil, about 10% (v/v) cedar oil, and about 50% (v/v) castor oil.

14. A composition according to claim 1 for controlling mosquitos comprising a final concentration of about 5% (v/v) lime oil, about 11% (v/v) basil oil, about 3% (v/v) celery extracts, about 8% (v/v) thyme oil, about 10% (v/v) cinnamon oil, about 9% (v/v) lemon eucalyptus oil, about 7% (v/v) lemon grass oil, and about 47% (v/v) castor oil.

15. A composition according to claim 1 for controlling mosquitos comprising a final concentration of about 15% (v/v) lime oil, about 14% (v/v) basil oil, about 6% (v/v) clove oil, about 4% (v/v) lilac oil, about 4% (v/v) cinnamon oil, about 10% (v/v) lemon eucalyptus oil, and about 47% (v/v) castor oil.

16. A composition according to claim 1 for controlling mosquitos comprising a final concentration of about 15% (v/v) lime oil, about 15% (v/v) basil oil, about 5% (v/v) clove oil, about 3% (v/v) lilac oil, about 4% (v/v) celery extracts, about 4% (v/v) cedar-wood oil, about 9% (v/v) thyme oil, about 5% (v/v) cinnamon oil, about 9% (v/v) lemon eucalyptus oil, about 2% (v/v) lemon grass oil, and about 30% (v/v) castor oil.

17. A method of controlling mosquitos, said method comprising applying the composition of any one of claim 1 to a target area containing mosquitos.

18. (canceled)

19. (canceled)

20. (canceled)

21. (canceled)

22. (canceled)

23. (canceled)

24. (canceled)

25. (canceled)

26. (canceled)

27. (canceled)
